(19) United States
(12) Patent Application Publication
(10) Pub. No.: US 2006/0239752 A1
(43) Pub. Date: Oct. 26, 2006

(54) Sheet body treating apparatus

(75) Inventors: Kenichi Shiraishi, Nara-shi (JP); Ryoichi Kawai, Kitakatsuragi (JP); Shigeo Miyamoto, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-Shi, Osaka (JP)

(21) Appl. No.: 10/540,860

(22) PCT Filed: Dec. 4, 2003
(86) PCT No.: PCT/JP03/15513

§ 371 Date: May 15, 2006

(30) Foreign Application Priority Data
Dec. 27, 2002 (JP) 2002-382461

(51) Int. Cl. B41J 29/02; B41J 29/12; B41J 3/39

(52) U.S. Cl. 400/691

(57) ABSTRACT

An object of the invention is to provide a sheet member processing apparatus by which a necessary working space is secured and a workability can be enhanced in doing maintenance. A housing space (32) in which processing means (26) is housed can be opened and closed by displacing a front cover potion (31) relative to a casing (30) of a casing (21). In the casing (21), a document discharge port (35) is formed upper than the front cover section (31). On the front cover section (31) is provided a document discharge tray (24) which receives a discharged document. When the cover section (31) is made to be displaced relative to the casing main body (30), the document discharge tray (24) is displaced together with the front cover section (31). This makes it possible to secure the large working space and enhance the workability, for instance, when an operator replaces consumable articles such as an ink cartridge (53).

### TECHNICAL FIELD

The present invention relates to a sheet member processing apparatus for performing a predetermined process on a sheet member.

### BACKGROUND ART

FIG. 10 is a cross sectional view schematically showing a facsimile apparatus 1 of a related art. In the facsimile apparatus 1, on an upper section of an apparatus base 3, an upper cover section 2 is provided so as to be capable of being angularly displaced about an axial line L2 with a part of a back side as a center. In a space 10 formed by these apparatus base 3 and upper cover section 2, a document reading unit 9 and an image forming unit 6 are provided.

The document reading unit 9 reads an image of a document, and simultaneously conveys the document along a conveyance path which is formed between the apparatus base 3 and the upper cover section 2 by a guiding member 5. On the apparatus base 3, a document discharge tray 4 is provided on a front section as a downstream side of the conveying direction so as to protrude forward in order to be capable of placing a read document thereon.

The image forming unit 6 is housed in a lower region of the document reading unit 9. The image forming unit 6 forms an image on a recording paper by use of a toner. The toner is a consumable article, and a cartridge for housing the toner must be replaced when the toner is consumed. Therefore, a front cover section 7 is provided on a front section of the apparatus base 3. The image forming unit 6 is constituted so that the front cover section 7 can be made to make angular displacement in an opening direction K so as to be capable of opening the space 10 and replacing the cartridge.

Moreover, in an another facsimile apparatus of related art, on an upper section of an apparatus main body, on which an image forming unit is provided, an upper cover section on which a document reading unit is provided, is provided so as to be capable of being angularly displaced about an angular displacement axial line which is disposed on a front section thereof. In this facsimile apparatus, an image reading unit is constituted so that the upper cover section is made to make angular displacement by pulling a front thereof upward against the apparatus body so as to have a forward-leaning posture, and a space in which the image forming unit is disposed is opened so that a cartridge can be replaced (refer to, for instance, Japanese Unexamined Patent Publication JP-A 11-258870 (1999)).

Further, in another facsimile apparatus of related art, on an upper section of a body of the facsimile apparatus, on which an image forming unit is disposed, are provided an upper cover section on which a document reading unit is disposed, and a document discharge tray on which a document read by the document reading unit is placed. The discharge tray is disposed so as to be angularly displaced, and when document reading is carried out, the discharge tray is positioned at a position protruding forward to place a document thereon, and when document reading is not carried out, the discharge tray is retracted partially covering the cover section (refer to, for example, Japanese Unexamined Patent Publication JP-A 2001-63901).

In the facsimile apparatus 1 shown in FIG. 10, the front cover section 7 can be made to make angular displacement so as to open the space 10, and a cartridge can be replaced, but the document discharge tray 4 exists on an upper side of an opening which is opened by the front cover section 7, and therefore the document discharge tray 4 becomes an impediment so that it is not possible to secure a large working space in order to do works such as maintenance. On the other hand, it is easily conceivable that the document discharge tray 4 is made to be detachable, but it takes troubles and workability is low since the document discharge tray 4 must be detached and attached on every occasion of maintenance. Only by thus providing the front cover section for forming the opening for maintenance on the front section, the maintenance cannot be facilitated.

Moreover, in the facsimile apparatus shown in the Japanese Unexamined Patent Publication JP-A 11-258870 (1999), in doing maintenance, the cover section must be made to make angular displacement to a front side by approximately 90 degrees, and a recording section provided on a lower section of the apparatus must be looked from above. Furthermore, a hand must be entered from above to the image forming unit placed on a back of the image reading unit so as to keep the upper cover section away. In addition, the cover section is provided with the image reading unit and has a larger weight compared to a mere cover, and therefore an operation of angular displacement is difficult. Consequently, the maintenance is difficult, and the workability is inversely low rather than resolving the problem of FIG. 10.

Moreover, the facsimile apparatus shown in the Japanese Unexamined Patent Publication JP-A 2001-63901 is constituted so as to be capable of evacuating the document discharge tray, but not constituted so as to be capable of securing the space for the maintenance although the constitution can show a beautiful appearance as a design.

As an apparatus thus equipped with a document reading unit and an image forming unit, there are, for example, a scanning printer, a multifunctional apparatus, and a compact copying machine as well as a facsimile apparatus. However, they are not constituted so as to enhance the workability of the maintenance such as a replacement of cartridges.

### DISCLOSURE OF INVENTION

Consequently, an object of the invention is to provide a sheet member processing apparatus which can secure a large working space and enhance a workability in doing maintenance.

The invention is a sheet member processing apparatus comprising:

processing means for performing a predetermined process on a sheet member;

a casing having a casing main body and a lid body, in which a housing space capable of being opened and closed by displacing the lid body relative to the casing main body, for housing the processing means is formed, and in an upper side than the lid body is formed a discharge port for discharging a sheet member processed by the processing means; and

a sheet member holding body for holding a sheet member discharged from the discharge port.

According to the invention, the casing has the casing main body and the lid body. In the casing is formed the housing space capable of being opened and closed by displacing the lid body relative to the casing main body. In the housing space is housed the processing means for performing the predetermined process on the sheet member. Further in the casing, the discharge port is formed in an upper side than the lid body. From the discharge port, discharged is the sheet member processed by the processing means. In the lid body, held is the sheet member discharged from the discharge port by the sheet member holding body. Since the sheet member holding body is thus provided on the lid body, the sheet member holding body can be made to be displaced together with the lid body relative to the casing main body when the lid body is made to be displaced relative to the casing main body. This enables that the sheet member holding body is displaced together with the lid body and disposed so as not to be an impediment when the lid body is made to be displaced relative to the casing main body so as to open the housing space. This makes it possible to secure a large working space by preventing the working space from being smaller due to the sheet member holding body as an impediment when an operator is doing maintenances, for instance, a work operation for replacing consumable articles such as an ink cartridge, and a work operation for removing dust attached to a roller for conveying the sheet member. Furthermore, the sheet member holding body is disposed at a position apart from the casing main body in doing maintenance and therefore, the housing space is prevented from being blocked by the sheet member holding body so that the operator can visually look at the housing space reliably. This makes it possible to enhance the workability.

Further, the invention is characterized in that:

the lid body is coupled so as to be capable of being angularly displaced about a predetermined lid body angular displacement axial line relative to the casing main body; and

the sheet member holding body is coupled so as to be capable of being angularly displaced about a holding body angular displacement axial line in parallel with the lid body angular displacement axial line relative to the lid body.

According to the invention, the lid body is coupled so as to be capable of being angularly displaced about the predetermined lid body angular displacement axial line relative to the casing main body. The sheet member holding body is coupled so as to be capable of being angularly displaced about the holding body angular displacement axial line in parallel with the lid body angular displacement axial line relative to the lid body. This makes it possible to angularly displace the sheet member holding body relative to the lid body so as to have a working space wide enough when the lid body is made to make angular displacement so as to open the housing space. In addition, the workability can be enhanced since it becomes easier for the operator to work by having a working space wide enough.

Further, the invention is characterized in that:

the casing main body has a base to which the lid body is coupled, and a cover section, and the casing main body is constituted to be capable of opening and closing the housing space by displacing the cover section relative to the base; and

in a state where a lid body is closed, the sheet member holding body is capable of being angularly displaced about a predetermined angular displacement axial line of the sheet member holding body between a holding position where the sheet member holding body is disposed so as to extend in a direction of moving away from a side of the casing in which a discharge port is formed and on which holding position the sheet member discharged from the discharge port is received, and a housing position which is positioned along the side of the casing in which the discharge port is formed so that the sheet member holding body partially contacts with the cover section, and in a state of being in the housing position a press force due to contact of the sheet member holding body with the cover is given to a direction for closing the cover section.

According to the invention, the casing main body has the base to which the lid body is coupled, and the cover section, and the casing main body is constituted to be capable of opening and closing the housing space by displacing the cover section relative to the base. The sheet member holding body can be displaced between the holding position and the housing position. At the holding position, in the state where the lid body is closed, the sheet member holding body is disposed so as to extend in the direction of moving away from the side of the casing in which the discharge port is formed, and the sheet member holding body receives the sheet member discharged from the discharge port. At the housing position, the sheet member holding body is disposed along the side of the casing in which the discharge port is formed so as to partially contacts with the cover section. In the state where the sheet member holding body is at the housing position, the press force due to the contact of the sheet member holding body with the cover section is given to the direction for closing the cover section. For instance, even when the operator touches the sheet member holding body and thereby, the sheet member holding body makes angular displacement and contacts with the cover section, the press force due to the sheet member holding body is given to the direction for closing the cover section. This prevents the cover section from making angular displacement in an opening direction by mistake. Consequently, by having the housing space being open, troubles such that a process on the sheet member is not performed can be prevented from occurring so that the process can be reliably performed on the sheet member.

Further, the invention is characterized in that:

the cover section is coupled to the base so as to be capable of being angularly displaced about a cover angular displacement axial line in parallel with the holding angular displacement axial line; and

the sheet member holding body has a convex section which contacts with the cover section in a state of being disposed at the housing position, and the convex section is formed so that in a state of contacting with the cover section, a pressing direction for pressing the cover section is a direction which is directed closer to the base than a virtual plane including a contact position of the convex section in the cover section and the cover angular displacement axial line.

According to the invention, the cover section is coupled to the base so as to be capable of being angularly displaced about the cover angular displacement axial line in parallel with the holding angular displacement axial line. The sheet member holding body has a convex section which contacts with the cover section in a state of being disposed at the housing position. The convex section of the sheet member holding body is formed so that in a state of contacting with the cover section, a pressing direction for pressing the cover section is a direction which heads for the base side closer than a virtual plane including a contact position of the convex section in the cover section and the cover angular displacement axial line. By thus forming the convex section of the sheet member holding body, when the convex section contacts with the cover section, the press force due to the contact of the convex section on the cover section can be given to the direction for closing the cover section. This makes it possible to reliably prevent the housing space from being opened by angularly displacing the cover section even when the operator touches the sheet member holding body by mistake and thereby the sheet member holding body and the cover section come in contact.

Further the invention is characterized in that:

the lid body is coupled in one side thereof to the casing main body so as to be capable of being angularly displaced about the predetermined lid body angular displacement axial line, and engaged in the other side thereof with the casing main body so as to be capable of releasing the engagement when an external force over a predetermined setting force is given to a direction for opening the housing space; and

the sheet member holding body is coupled to the other side of the lid body.

According to the invention, the lid body is coupled in one side thereof to the casing main body so as to be capable of being angularly displaced about the predetermined lid body angular displacement axial line, and engaged in the other side thereof with the casing main body so as to be capable of releasing the engagement when an external force over a predetermined setting force is given to a direction for opening the housing space. In a state where the lid body is engaged with the casing main body, by use of the sheet member holding body coupled to the other side of the lid body, the engagement of the lid body and the casing main body can be released by giving the external force over the setting force. This makes it possible to use the sheet member holding body not only as means for holding the sheet member from the discharge port, but also as means for operating the lid body so as to open the housing space. Further the sheet member holding body is coupled to the other side of the lid body. This makes it possible to efficiently give the external force over the setting force to the other side of the lid body by the sheet member holding body so that the engagement of the lid body and the casing main body can be easily released compared to the case of being coupled between the one side and the other side, and the case of being coupled closer to the one side. This makes it possible to prevent the lid body and the sheet member holding body from being deformed and broken.

Further, the invention is characterized in that the sheet member holding body is disposed so as to be detachable from the lid body when an external force in a direction along the holding body angular displacement axial line is given.

According to the invention, the sheet member holding body is disposed so as to be detachable from the lid body when an external force in a direction along the holding body angular displacement axial line is given. Thereby, the sheet member holding body is easily detached from the lid body when the operator touches the sheet member holding body by mistake if the external force given to the sheet member holding body is in a direction along the holding angular displacement axial line. Consequently, it is possible to prevent the lid body and the sheet member holding body from being broken by the external force.

### BRIEF DESCRIPTION OF DRAWINGS

Other and further objects, features, and advantages of the invention will be more explicit from the following detailed description taken with reference to the drawing wherein:

FIG. 1 is a cross sectional view schematically showing a communication apparatus 20 according to one embodiment of the invention;

FIG. 2 is a front view showing the communication apparatus 20 seen from above, of which thickness is partially omitted in FIG. 1;

FIG. 3 is a view for explaining an operation of a front cover section 31 and a document discharge tray 24 when an ink cartridge 53 is replaced;

FIG. 4 is an enlarged cross sectional view showing the front cover section 31 and the document discharge tray 24 in FIG. 3;

FIG. 5 is a plan view showing the communication apparatus 20 seen from above in a state where an upper cover section 41 is open;

FIG. 6 is a view for explaining an operation of the upper cover section 41 when the document discharge tray 24 having no convex section 24a is displaced toward a housing position of a document tray;

FIG. 7 is a view for explaining an operation of the upper cover section 41 when the document discharge tray 24 having the convex section 24a is displaced toward the housing position of the document tray;

FIG. 8 is a view for explaining a relation of the document discharge tray 24 and the front cover section 31;

FIG. 9 is a view for explaining a document discharge tray 24B equipped with a communication apparatus 20B according to another embodiment of the invention; and

FIG. 10 is a cross sectional view schematically showing one example of the facsimile apparatus 1.

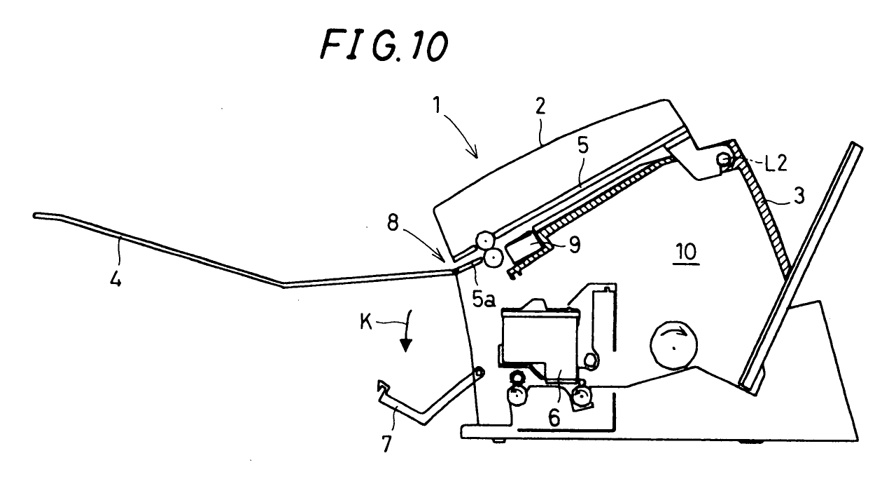

### BEST MODE FOR CARRYING OUT THE INVENTION

Now referring to the drawings, preferred embodiments of the invention are described below.

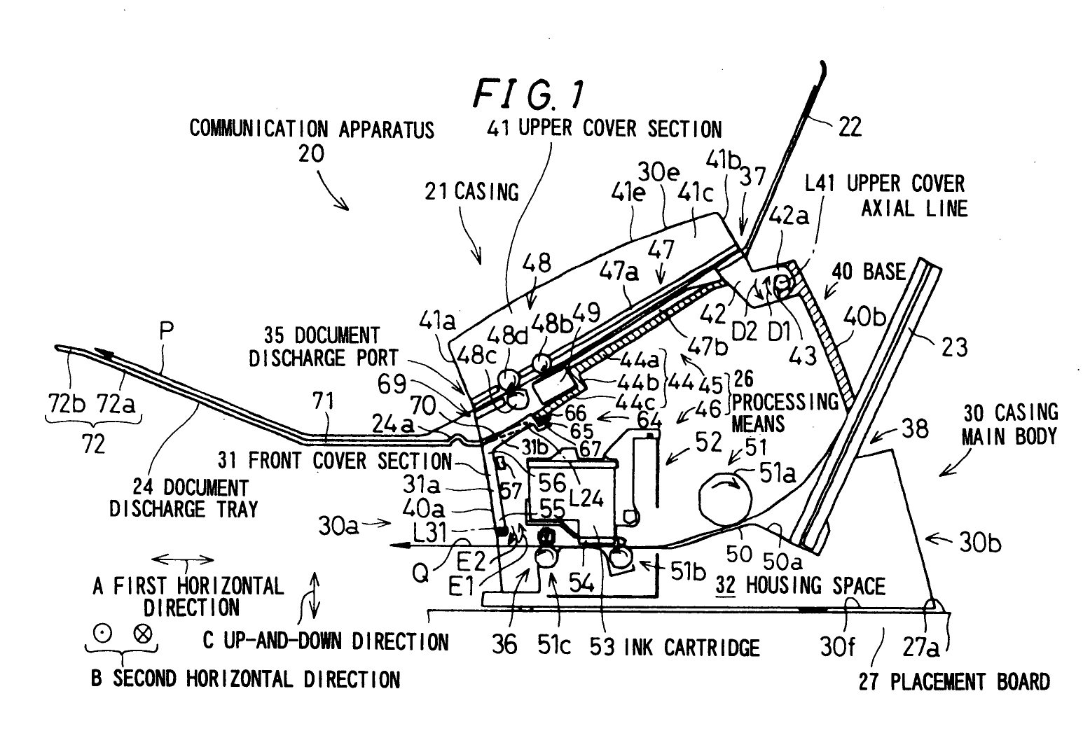

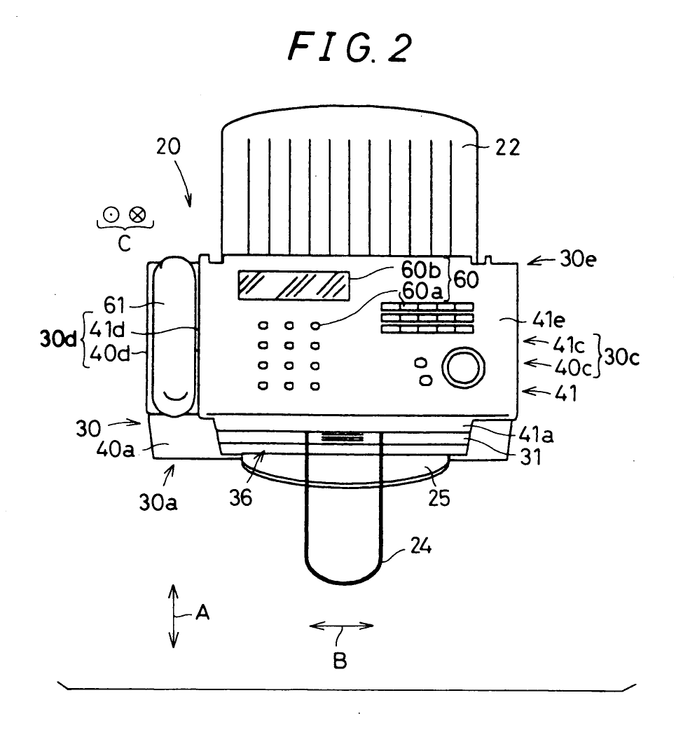

FIG. 1 is a cross sectional view schematically showing a communication apparatus 20 according to one embodiment of the invention. FIG. 2 is a front view showing the communication apparatus 20 seen from above. In FIG. 1, a thickness is partially omitted. In the invention, a term “up-and-down direction” means an up-and-down direction in a state where the communication apparatus 20 as a sheet member processing apparatus is placed and used, for instance, on a placement board 27. In the invention, a term “upper” means upper in a state where the communication apparatus 20 is placed and used on the placement board 27 while a term “lower” means lower in a state where the communication apparatus 20 is used as described above. In the invention, a term “schematically vertical” includes vertical while a term “schematically parallel” includes parallel. The communication apparatus 20 as a sheet member processing apparatus is an apparatus for communicating with other communication apparatuses through a communication line. The communication apparatus 20 is placed and used, for instance, on a placement surface 27a as a horizontal plane of the placement board 27. The communication apparatus 20 performs a predetermined process on a sheet member by use of processing means 26 described hereinbelow.

The sheet member includes a reading sheet and a recording sheet which are formed of paper and materials other than paper. The predetermined process includes an image reading process and an image forming process. The image reading process is a process for reading an image formed on a document as the reading sheet. The image forming process is a process for forming an image on a recording material as the recording sheet. The state where the communication apparatus 20 is used is a state of communicating other communication apparatuses through the communication line. The communication apparatus 20 is, for instance, a facsimile apparatus. The communication apparatus 20 comprises a casing 21, a document supply tray 22, a recording material supply tray 23, a document discharge tray 24, a recording material discharge tray 25, and processing means 26.

The casing 21 is a container in a general box form. The casing 21 has a casing main body 30 and a front cover section 31. In the casing 21 is formed a housing space 32 capable of being opened and closed by displacing the front cover section 31 relative to the casing main body 30. The casing main body 30 has a first main body side 30a, a second main body side 30b, a third main body side 30c, a fourth main body side 30d, a first main body bottom section 30e, and a second main body bottom section 30f. The first main body side 30a and the second main body side 30b confront so as to be apart from each other in a first horizontal direction A. The first horizontal direction A is one predetermined direction of directions which are vertical to an up-and-down direction C in a state where the communication apparatus 20 is placed and used on the placing board 27.

The first main body side 30a is one side of the casing main body 30 facing an operator who does various works such as maintenance of the communication apparatus 20. The front cover section 31 is coupled to the first main body side 30a. The first main body side 30a is, along an upper direction, inclined to a direction of moving away from the second main body side 30b. The second main body side 30b is, along an upper direction, inclined to a direction close to the first main body side 30a. The second main body side 30b has an upper side end thereof disposed upper than an upper side end of the first main body side 30a.

The third main body side 30c and the fourth main body side 30d confront so as to be apart from each other in a second horizontal direction B. The second horizontal direction B is a direction which is vertical to the first horizontal direction A and the up-and-down direction C. The third main body side 30c and the fourth main body side 30d are both disposed so as to extend in the up-and-down direction C. The third main body side 30c and the fourth main body side 30d are provided between the first main body side 30a and the second main body side 30b so that the first main body side 30a and the second main body side 30b are coupled to each other.

The first main bottom section 30e and the second main body bottom section 30f confront so as to be apart from each other in the up-and-down direction C. The first main bottom section 30e is one bottom section of the casing main body 30, and disposed upper than the second main body bottom section 30f. The fist main body bottom section 30e is inclined downward from the second main body side 30b to the first main body side 30a. The first main body bottom section 30e is provided between the first main body side 30a and the second main body side 30b so that the first main body side 30a and the second main body side 30b are coupled to each other. Furthermore, the fist main body bottom section 30e is provided between the third main body side 30c and the fourth main body side 30d so that the third main body side 30c and the fourth main body side 30d are coupled to each other.

The second main body bottom section 30f is another bottom section of the casing main body 30, and confronts the placement surface 27a of the placement board 27. In addition, the second main body bottom section 30f is disposed along the placement surface 27a. The second main body bottom section 30f is provided between the first main body side 30a and the second main body side 30b so that the first main body side 30a and the second main body side 30b are coupled to each other. Furthermore, the second main body bottom section 30f is provided between the third main body side 30c and the fourth main body side 30d so that the third main body side 30c and the fourth main body side 30d are coupled to each other. The housing space 32 is surrounded by the first to fourth main body sides 30a to 30d, the first main body bottom section 30e, and the second main body bottom section 30f.

On the casing 21, formed upper than the front cover section 31 is a discharge port for discharging a sheet member on which a predetermined process is performed. In addition, in the casing, a supply port for supplying a sheet member is formed in order that the processing means 26 performs a predetermined process. Specifically, in the casing main body 30 of the casing 21 are formed, as discharge ports, a document discharge port 35 and a recording material discharge port 36, as supply ports, a document supply port 36 and a recording material supply port 38.

The document discharge port 35 is a discharge port for discharging the document on which the image reading process has been performed. The recording material discharge port 36 is a discharge port for discharging the recording material on which the image forming process has been performed. The document discharge port 35 and the recording material discharge port 36 are formed in the first main body side 30a of the casing main body 30. The document discharge port 35 is formed upper than the front cover section 31. In the embodiment, only the document discharge port 35 of the document discharge port 35 and the recording material discharge port 36 is formed upper than the front cover section 31. The recording material discharge port 36 is formed lower than the front cover section 31.

A document supply port 37 is a supply port for supplying the document on which the image recording process has not been performed. The recording material supply port 38 is a supply port for supplying a recording material on which the image forming process has not been performed. The document supply port 37 and the recording material supply port 38 are formed in the second main body side 30b of the casing main body 30. The document supply port 37 is formed upper than the document discharge port 35 and the recording material supply port 38. The recording material supply port 38 is formed lower than the document supply port 37 and upper than the recording material discharge port 36. The housing space 32 and an outside of the communication apparatus 20 are communicated with each other by the document discharge port 35, the recording material discharge port 36, the document supply port 37, and the recording material supply port 38.

The casing main body 30 has a base 40 and an upper cover section 41. The casing main body 30 is constituted so that the housing space 32 can be opened and closed by displacing the upper cover section 41 relative to the base 40. The front cover section 31 is coupled to the base 40 of the casing main body 30. The base 40 has a first base side 40a, a second base side 40b, a third base side 40c, a fourth base side 40d, and a base upper section 40e. The first base side 40a is a part of the first main body side 30a. The second base side 40b is a part of the second main body side 30b. The second base side 40b has an upper side end thereof disposed upper than an upper side end of the first base side 40a. The third base side 40c is a part of the third main body side 30c. The fourth base side 40d is a part of the fourth main body side 30d. The third base side 40c and the fourth base side 40d are provided between the first base side 40a and the second base side 40b so that the first base side 40a and the second base side 40b are coupled to each other.

The base upper section 40e is one bottom section of the base 40, and disposed upper than a bottom section of the base 40, facing the placement board 27. The bottom section of the base 40, facing the placement board 27 is the second main body bottom section 30f. A base upper section 44 is coupled to the second base side 40b. In addition, the base upper section 44 is provided between the third main body side 30c and the fourth main body side 30d, for instance, in the second direction B so that the third main body side 30c and the fourth main body side 30d are coupled to each other. The base upper section 44 is disposed so as to extend from an upper side end of the second base side 40b to a vicinity of an upper side end of the first base side 40b in the first horizontal direction A. The base upper section 44 is inclined downward from the second base side 40b to the first base side 40a. Specifically, the base upper section 44 has a first extending section 44a, a second extending section 44b, and a third extending section 44c.

The first extending section 44a is disposed so as to protrude from the upper side end of the second base side 40b, and extend toward the first base side 40a. The first extending section 44a is inclined downward from the second base side 40b to the first base side 40a. The second extending section 44b is schematically vertical to the first extending section 44a, and protrudes downward from an end closer to the first base end 40a of the first extending section 44a. The third extending section 44c is schematically vertical to the second extending section 44b, and disposed so as to extend downward from a lower side end of the second extending section 44b to the first base end 40a. The third extending section 44c is inclined downward from the second base side 40b to the first base side 40a.

The upper cover section 41 as a cover section is disposed upper than the base 40. The upper cover section 41 has a first upper cover side 41a, a second upper cover side 41b, a third upper cover side 41c, a fourth upper cover side 41d, and an upper cover upper section 41e. The first upper cover side 41a is another part of the first main body side 30a. The second upper cover side 41b is another part of the second main body side 30b. The third upper cover side 41c is another part of the third main body side 30c. The fourth upper cover side 41d is another part of the fourth main body side 30d.

The third upper cover side 41c and the fourth upper cover upper section 41e are provided between the first upper cover side 41a and the second upper cover side 41b so that the first upper cover side 41a and the second upper cover side 41b are coupled to each other. The upper cover upper section 41e is a part of the first main body bottom part 30e. The upper cover upper section 41e is provided between the first upper cover side 41a and the second upper cover side 41b so that the first upper cover side 41a and the second upper cover side 41b are coupled to each other. Furthermore, the upper cover side 41e is provided between the third upper cover side 41c and the fourth upper cover side 41d so that the third upper cover side 41c and the fourth upper cover side 41d are coupled to each other.

The first main body side 30a is composed of the first base side 40a and the first upper cover side 41a. The second main body side 30b is composed of the second base side 40b and the second upper cover side 41b. The third main body side 30c is composed of the third base side 40c and the third upper cover side 41c. The fourth main body side 30d is composed of the fourth base side 40d and the fourth upper cover side 41d. The first main body bottom section 30e is composed of the base upper section 40e and the upper cover upper section 41e.

The first upper cover side 41a is provided, in detail, along one virtual plane which is inclined to a direction of moving away from the second upper cover side 41b along an upper direction. The second upper cover side 41b is disposed, in detail, so as to be schematically parallel to the second base side 40b and closer to the first main body side 30a compared to the second base side 40b in the first horizontal direction A. The fourth upper cover side 41d is disposed, in detail, so as to be schematically parallel to the fourth base side 40d and closer to the third main body side 30c compared to the fourth base side 40d in the second horizontal direction A. The upper cover upper section 41e is provided along one virtual curved surface which smoothly curves downward from the second upper cover side 41b to the first upper cover side 41a.

The upper cover section 41 is provided on the base 40 so as to be capable of being angularly displaced about an upper cover axial line L41 as a cover angle displacement axial line. The upper cover axial line L41 is parallel to the second horizontal direction B. The housing space 32 is constituted so as to be capable of being opened and closed by displacing the upper cover section 41 relative to the base 40. Specifically, the second base side 40b of the base 40 is provided with an upper cover angle displacement axis 43 having the upper cover axial line L41. The upper cover potion 41 has a support angle 42, and is coupled to the base 40 on one end 42a of the support angle 42. The one end 42a of the support angle 42 has a through hole penetrating in the second horizontal direction B formed therein, and is formed so as to have a U shape of which a part in a circumferential direction opens outward in radial direction. In a state where the communication apparatus 20 is used, the one end 42a of the support angle 42 is formed so as to have a part thereof in the circumferential direction opens downward.

The support angle 42 is engaged with the upper cover angle displacement axis 43 by having the one end 42a thereof fitted in the upper cover angle displacement axis 43 so as to be capable of being angularly displaced. This makes it possible to easily couple the upper cover section 41 to the base 40, and angularly displace the upper cover section 41 easily relative to the base 40 with a simple constitution. For instance, when the operator gives a predetermined external force, the support angle 42 has the engagement with the upper cover angle displacement axis 43 released.

In addition, the first upper cover side 41a is provided at a slant, along an upper direction, so as to be apart from the second upper cover side 41b. This enables that the operator easily gives a force for making angular displacement to a first upper cover angle displacement direction E1 relative to the upper cover section 41 when the upper cover section 41 is operated so as to open the housing space 32 in a state where the operator confronts the first main body side 30a. Consequently, it is possible to enhance an operability of the communication apparatus 20.

When the upper cover section 41 makes angular displacement toward a first upper cover angle displacement direction D1 in a state where the communication apparatus 20 is used, the housing space 32 is made to be open. The first upper cover angular displacement direction D1 is a direction in which the upper cover section 41 makes angular displacement so as to be apart from the base 40 among the angular displacement directions about the upper cover axial line L41 of the upper cover section 41. When the upper cover section 41 is made to be displaced toward a second upper cover angular displacement direction D2 in a state where the housing space 32 is open, the housing space 32 is closed. The second upper cover angular displacement direction D2 is a direction in which the upper cover section 41 makes angular displacement so as to be close to the base 40 among the angular displacement directions about the upper cover axial line L41 of the upper cover section 41. It is thus possible to open and close the housing space 32 by making the upper cover section 41 which is coupled to the base 40 to make angular displacement relative to the base 40.

The document discharge port 35 is, in detail, formed between the first base side 40a and the first upper cover side 41a in the first main body side 30a. The recording material discharge port 36 is, in detail, formed in the first base side 40a in the first main body side 30a. In addition, the document supply port 37 is, in detail, formed between the second base side 40b and the second upper cover side 41b in the second main body side 30b. The recording material supply port 38 is, in detail, formed in the second base side 40b in the second main body side 30b.

The document supply tray 22 and the recording material supply tray 23 are both provided on the second main body side 30b of the casing main body 30. The document supply tray 22 holds the document which is supplied to the processing means 26. The document supply tray 22 holds the document at a position which the document can be supplied from the document supply port 37. The recording material supply tray 23 holds a recording material which is supplied to the processing means 26. The recording material supply tray 23 holds the recording material at a position which the recording material can be supplied from the recording material supply port 38. The recording material supply tray 23 is disposed lower than the document supply tray 22. In the embodiment, the recording material supply tray 23 has a part thereof housed in the housing space 32. In addition, the recording material supply tray 23 is biased by bias means such as a spring member from an opposite side of an after-described pickup roller 51a. This bias force allows the recording material supply tray 23 to coordinate with the pickup roller 51a so as to have the recording member sandwiched therebetween.

When the housing space 32 is opened by the upper cover section 41, the document supply tray 23 and the document held on the document supply tray 23 are detached from the casing main body 30. Furthermore, in a state where the housing space 32 is opened by the upper cover section 41, the upper cover section 41 is held by the base 40 in a state where the second upper cover side 41b contacts with the base upper section 44.

The document discharge tray 24 as a sheet member holding body holds the document which is discharged from the document discharge port 35. The document discharge tray 24 is provided on the front cover section 31. A detailed description of the document discharge tray 24 will be described hereinbelow. The recording material discharge tray 25 holds a recording material which is discharged form the recording material discharge port 36. The recording material discharge tray 25 is provided so as to be capable of slide displacement in the first horizontal direction A relative to the casing main body 30. For instance, a user operates the recording material discharge tray 25 and thereby, the recording material discharge tray 25 can be made to be disposed at a recording material holding position and a recording material tray housing position. At the recording material holding position, the recording material discharge tray 25 is disposed so as to extend in a direction of moving away from the first main body side 30a, and holds the recording material which is discharged. At the recording material tray housing position, the recording material discharge tray 25 is housed in the casing main body 30, specifically in a housing space formed on the second main body bottom section 30f.

The processing means 26 has document processing means 45 and recording material processing means 46. The document processing means 45 performs the image reading process on the document. The recording material processing means 46 performs the image forming process on a recording material. In the housing space 32, there are a region for housing the document processing means 45 on an upper side thereof and a region for housing the recording material processing means 46 on a lower side thereof. The document processing means 45 comprises a document guide section 47, a document conveying section 48, and a document reading section 49. The document guide section 47 guides the document from the document supply port 37 to the document discharge port 35. The document guide section 47 has an upper guide section 47a and a lower guide section 47b.

The upper guide section 47a and the lower guide section 47b confront so as to be apart from each other in the up-and-down direction. The upper guide section 47a is disposed so as to be integrated with the upper cover section 41. The upper guide section 47a is provided in the first horizontal direction A between the first upper cover side 41a and the second upper cover side 41b. The lower guide section 47b is disposed upper than the base 40 and provided along the base upper section 44. In addition, the lower guide section 47b is provided in the first horizontal direction A between the first base side 40a and the second base side 40b. The upper guide section 47a and the lower guide section 47b are provided at a downwardly slant from the document supply port 37 to the document discharge port 35 in a state where the communication apparatus 20 is used. In the embodiment, the upper guide section 47a and the lower guide section 47b are provided so as to be schematically parallel to the base upper section 44 in a state where the communication apparatus 20 is used.

By the upper guide section 47a and the lower guide section 47b, formed is a document conveyance path which communicates the document supply port 37 with the document discharge port 35. The document is supplied from the document supply port 37 which is located upstream of the document conveyance path, and guided by the document guide section 47, and then discharged from the document discharge port 35 which is located downstream of the document conveyance path.

The upper guide section 47a has a lock mechanism (not shown) on the base 40, which is capable of being engaged and releasing the engagement. The upper guide section 47a is engaged with the base 40 by the lock mechanism in a state where the housing space 32 is closed. The operator gives the external force upwardly to the upper cover section 41 and thereby, the engagement of the upper guide section 47a and the base 40 by the lock mechanism can be easily released. In addition, on the upper guide section 47a and the lower guide section 47b, a through hole is each formed in order to provide the document conveying section 48 and the document reading section 49 e.g. are provided so as to face the document conveyance path. Moreover, the upper guide section 47a and the lower guide section 47b are provided, for instance, in the second horizontal direction B between the third main body side 30c and the fourth main body side 30d.

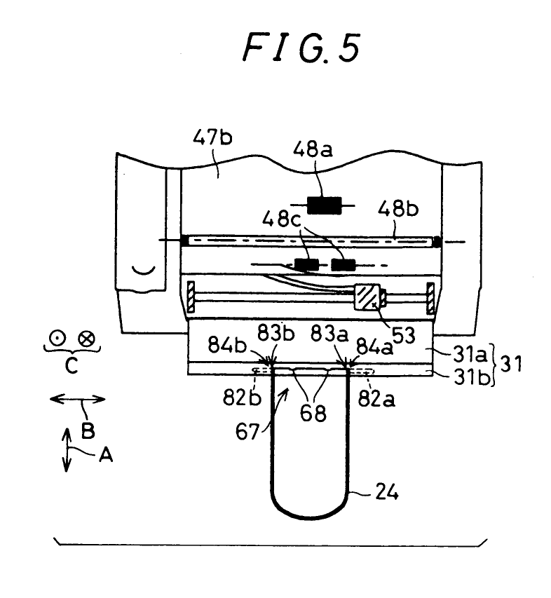

The document conveying section 48 is provided so as to face the document conveyance path, and conveys the document from the document supply port 37 toward the document discharge port 35. The document conveying section 48 comprises a document supply roller 48a (refer to FIG. 5), a document feeding roller 48b, a document discharge roller 48c, and a document discharge auxiliary roller 48d. The document supply roller 48a, the document feeding roller 48b, the document feeding roller 48c and the document auxiliary roller 48d are each provided so as to be capable of rotating about an axial line in parallel with the second horizontal direction B. The document supply roller 48a, the document feeding roller 48b, the document discharge roller 48c, and the document discharge auxiliary roller 48d are held on the casing main body 30, for instance, rotary shafts thereof so as to be capable of rotating.

The document supply roller 48a, the document feeding roller 48b, and the document discharge roller 48c are disposed so as to be apart from each other in this order from an upstream side of the document conveyance path toward a downstream side of the document conveyance path. The document supply roller 48a is provided either on the base 40 or on the upper cover section 41. The document supply roller 48a draws the document sheet by sheet from the document supply tray 23 into the document conveyance path in coordination with detaching means (not shown) by which a plurality of sheet members are detached sheet by sheet. The document feeding roller 48b is provided either on the upper guide section 47a or on the lower guide section 47b. In the embodiment, the document feeding roller 48b is provided on the base 40.

The document discharge roller 48c is provided either on the base 40 or on the upper cover section 41. In the embodiment, the document discharge roller 48c is provided on the base 40. The document discharge auxiliary roller 48d confronts the document discharge roller 48c, and is provided on the upper cover section 41. The document discharge auxiliary roller 48d conveys the document while having the document sandwiched in coordination with the document discharge roller 48d. Each roller 48a to 48d of the document conveying section 48 is rotationally driven by driving means (not shown). In particular, the document feeding roller 48b is rotationally driven with accuracy by the driving means. Incidentally, the document discharge auxiliary roller 48d may not be rotationally driven by the driving means, but be rotated by being driven by a rotation of the document discharge roller 48c.

The document reading section 49 is disposed so as to face the document conveyance path and reads an image which is formed on the document. The document reading section 49 is realized, for instance, by an image sensor of a cohesive type. The document reading section 49 is disposed so that one surface facing the document conveyance path thereof makes one general plane with one surface facing the document conveyance path of the lower guide section 47b. This allows the document to be smoothly conveyed so that the image reading process can be reliably performed. In addition, the document reading section 49 confronts the document feeding roller 48b and contacts with the document feeding roller 48b. In the embodiment, the document reading section 49 is held from a lower side by the third extending section 44c in a state of being contacting with the second extending section 44b of the base upper section 44.

For instance, when the image reading process is performed by the document processing means 45, the document which is held on the document supply tray 22 is conveyed sheet by sheet by the document supply roller 48a, the document feeding roller 48b, the document discharge roller 48c, and the document discharge auxiliary roller 48d along the first guide section 47a and the second guide section 47b as shown by an arrow P. An image formed on the document is read by the document reading section 49 on a way of the document conveyance path. The document of which the image is read is discharged from the document discharge port 35 and held by the document discharge tray 24. Information which represents the image of the document read by the document processing means 45 is transmitted, for instance, from the apparatus itself to another communication apparatus through a communication line.

The recording material processing means 46 comprises a recording material guide section 50, a recording material conveying section 51, and an image forming section 52. The recording material guide section 50 guides the recording material from the recording supply port 38 toward the recording discharge port 36. The recording material guide section 50 forms the recording material conveyance path which extends between the first base side 40a and the second base side 40b. In addition, the recording material guide section 50 has a recording material contact section 50a for preventing the recording material from being displaced by an own weight thereof. The recording material is held on the recording supply tray 23 in a state where a leading end thereof contacts with the recording material contact section 50a.

The recording conveyance section 51 is disposed so as to face the recording material conveyance path. The recording material conveyance section 51 conveys the recording material from the recording material supply port 38 located in the upstream side of the recording material conveyance path toward the recording material discharge port 36 located in the downstream side of the recording material conveyance path. The recording material conveying section 51 comprises the pickup roller 51a, and first and second recording material feeding rollers 51b and 51c. The pickup roller 51a, and the first and second recording material feeding rollers 51b and 51c are each disposed so as to be capable of rotating about axial lines which are parallel to the second horizontal direction. The pickup roller 51a, and the first and second recording material feeding roller 51b and 51c have, for instance, rotary shafts thereof which are held on the casing main body 30 so as to be capable of rotating.

The pickup roller 51a, the first recording material feeding roller 51b, and the second recording material feeding roller 51c are disposed so as to be apart from each other in this order from the upstream side of the recording material conveyance path toward the downstream side of the recording material conveyance path. The pickup roller 51a is disposed so as to confront the recording material supply tray 23. The pickup roller 51a has the recording material sandwiched in coordination with the recording material supply tray, and draws the recording material into the recording material conveyance path by rotating. The first recording material feeding roller 51b has two rollers confronting each other. The two rollers rotate while having the recording material sandwiched therebetween so as to convey the recording material toward the recording material discharge port 36. The second recording material feeding roller 51c has two rollers confronting each other. These two rollers rotate while having the recording material sandwiched therebetween, and thereby convey the recording material toward the recording material discharge port 36. Each roller 50a to 50c of the recording material conveying section 51 is rotationally driven by the driving means (not shown).

The image forming section 52 is disposed so as to face the recording material conveyance path, and forms an image on the recording material. The image forming section 52 has an ink cartridge 53 and a recording head 54. The ink cartridge 53 is a consumable article, and disposed on the image forming section 52 so as to be replaced by the operator. The recording head 54 forms the image on the recording material by use of an ink which is supplied from the ink cartridge 53. The image forming section 52 is disposed close to the front cover section 31 and below the base upper section 44.

For instance, when information is transmitted from another communication apparatus, the image forming process is performed by the recording material processing means 46. In this case, the recording material which is held on the recording material supply tray 23 is conveyed by the pickup roller 51a, and the first and second recording material feeding rollers 51b and 51c as shown by an arrow Q. On the recording material which is conveyed, is formed an image which is based on the transmitted information, on the way of the recording material conveyance path by the image forming section. The recording material on which the image is formed is discharged from the recording material discharge port 36, and held by the recording material discharge tray 25.

The front cover section 31 as a lid body has resiliency, and formed of, for instance, plastic material or the like. The front cover section 31 is coupled to the first main body side 30a so as to be capable of angular displacement about the front cover axial line L31 relative to the casing main body 30. The front cover axial line L31 is a predetermined lid body angular displacement axial line, and parallel to the upper cover axial line L41.

The cover section 31 is formed so as have a cross section thereof, which is vertical to the front cover axial line L31, in a general L shape. The front cover section 31 has a first front cover side 31a as one side of the front cover section 31, and a second front cover side 31b as another side of the front cover section 31. The first front cover side 31a and the second front cover side 31b both extends in the second direction B between a vicinity of the third main body side 30c and a vicinity of the fourth main body side 30d. The first front cover side 31a is coupled to the first base side 40a so that one end 55 thereof is capable of being angularly displaced about the front cover axial line L31. On other end 56 of the first front cover side 31a, the second front cover side 31b is provided so as to protrude.

The front cover section 31 is coupled so as to be capable of being angularly displaced about the front cover axial line L31 on the first front cover side 31a relative to the casing main body 30. The first front cover side 31a is made to make angular displacement about the front cover axial line L31 relative to the casing main body 30, and thereby the housing space 32 is opened and closed. In a state where the communication apparatus 20 is used, when the front cover side 31a makes angular displacement toward a first front cover angular displacement direction E1 relative to the casing main body 30, the housing space 32 is made to be open. The first front cover angular displacement direction E1 is a direction in which the front cover section 31 makes angular displacement so as to be apart from the casing main body 30 among angular displacement directions about the front cover axial line L31 of the front cover section 31. In a state where the front cover section 31 opens the housing space 32, the other end 56 of the first front cover side 31a is apart from the first base side 40a, and the second front cover side 31b is disposed outside of the communication apparatus 20 from the housing space 32.

In a state where the housing space 32 is open, when the first front cover side 31a makes angular displacement relative to the casing main body 30 toward a second front cover angular displacement direction E2, the housing space 32 is made to be closed. The second front cover angular displacement direction E2 is a direction in which the front cover section 31 makes angular displacement so as to be close to the first base side 41a among angular displacement directions about the front cover axial line L31 of the front cover section 31. In a state where the front cover section 31 closes the housing space 32, the first front cover side 31a is disposed along the first base side 40a. In this state, the one end 55 of the first front cover side 31a is disposed lower than the other end 56 of the first front cover side 31a.

Moreover, in a state where the front cover section 31 closes the housing space 32, the second front cover side 31b is housed in the housing space 32, and disposed so as to extend toward the second main body side 30b. In this state, the second front cover side 31b confronts so as to be apart from the lower guide section 47b. Thereby, formed is an operation space 69 in which the operator can operate the second front cover side 31b. By angularly displacing the front cover section 31 relative to the casing main body 30, the housing space 32 can be opened and closed.

In addition, in the housing space 32, a locking section 57 is housed in a state of being disposed close to the first front cover side 31a. The locking section 57 is held, for instance, by the third main body side 30c and the fourth main body side 30d. When the housing space 32 is closed by the front cover section 31, the locking port 57 locks the first front cover side 31a so that the front cover section 31 does not fall down toward the housing space 32. By providing the locking section 57, it is possible to set the front cover section 31 at a position along the first base side 40a when the housing space 32 is closed.

The base upper section 44 has the front cover section 31 and a base engaging section 64 which is capable of being engaged and releasing the engagement. Specifically, the base engaging section 64 is provided on an end which faces the first base side 40a of the third extending section 44a. The base engaging section 64 is formed so as to have a U shape which generally opens downward. The front cover section 31 is engaged with the casing main body 30 so as to be capable of releasing the engagement when an external force over a predetermined setting force is given to a direction for opening the housing space 32 on the front cover side 31b. The second front cover side 31b has the base engaging section 64 of the base upper section 44 and a cover engaging section 67 which is capable of being engaged and releasing the engagement. The cover engaging section 67 is engaged with the base engaging section 64 when the front cover section 31 is disposed at a position on which the housing space 32 is closed. The operator inserts a hand into the operation space 69 and gives the external force over the setting force to the second front cover side 31b and thereby, the engagement of the cover engaging section 67 and the base engaging section 64 can be released. This displaces the front cover section 31 to the first front cover angular displacement direction E1, and the housing space 32 is opened.

The above-described communication apparatus 20 further comprises an operation panel section 60 and a hand set 61. The operation panel section 60 is means for giving a result of an input operation by the operator to a control means (not shown) of the communication apparatus 20 and displaying in order to inform the operator of various information. The operation panel section 60 is provided on the first main body bottom section 30a of the casing main body 30. Specifically, the operation panel section 60 is disposed on the upper cover section 41. The operation panel section 60 has an operation section 60a and a display section 60b. The operation section 60a has operation buttons such as a numeric keypad and a shortening button. The operation section 60a is disposed at a position on which the operation section 60a is easily operated in a state where the operator confronts the first main body side 30a. The operator can operate the operation buttons of the operation section 60a and input various setting. On the display section 60b, displayed is various information such as the result of the input operation by the operator and an operational state of the communication apparatus 20. The display section 60b is realized, for instance, by the liquid crystal display (abbreviated as LCD).

The upper cover section 41c is inclined downward from the second upper cover side 41b to the first upper cover side 41a as described above. This causes no troubles such that it is hard to see the operation buttons and the display section 60b which are disposed at a position away from the operator and that the operation buttons are pushed by mistake. Consequently, the operator can easily operate the operation buttons, and easily and reliably confirm the information which is displayed on the display section 60b.

The communication apparatus 20 is, for instance, connected to a phone line and has a function of a telephone apparatus. The hand set 61 is means by which the operator communicated with others. The hand set 61 is held, for instance, at a predetermined holding position of the base upper section 40e. By use of the hand set 61, the operator can communicate with friends and the like, for instance, by operating the operation section 60a and inputting telephone numbers.

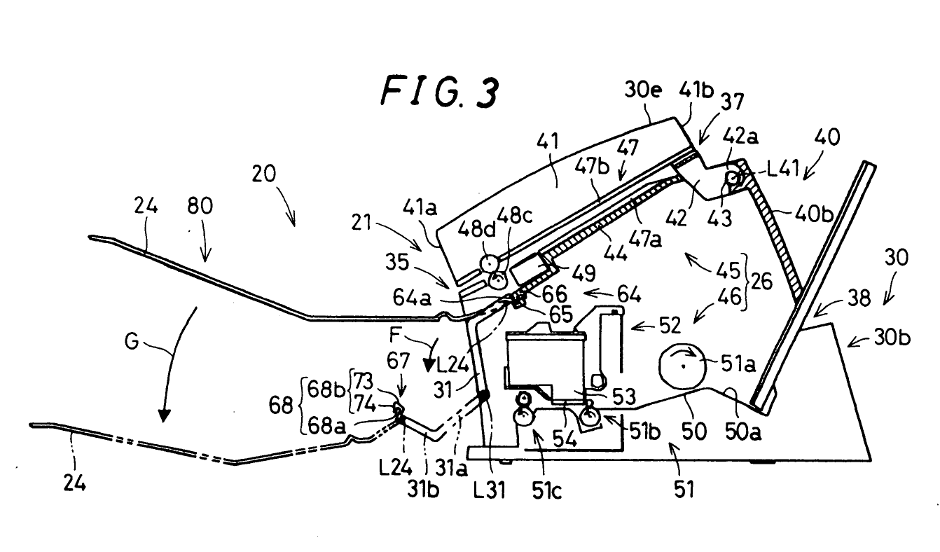

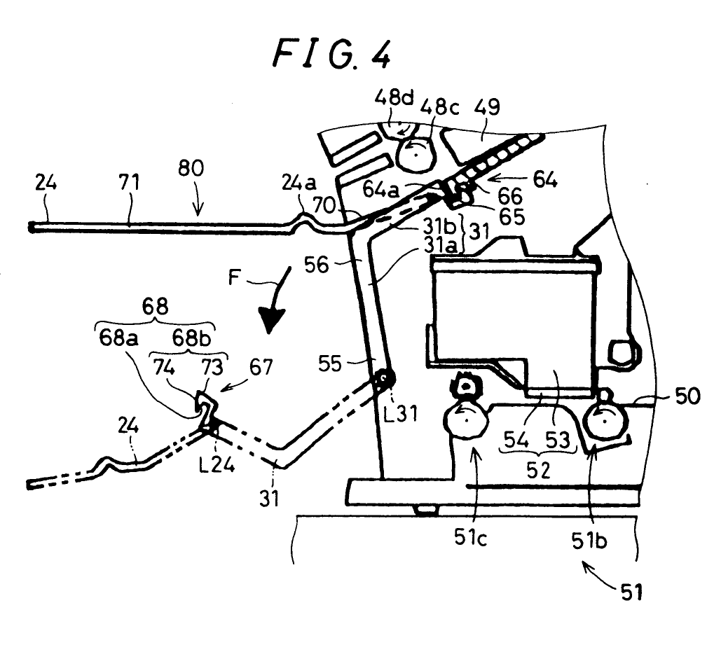

FIG. 3 is a view for explaining an operation of the front cover section 31 and the document discharge tray 24 when the ink cartridge 53 is replaced. FIG. 4 is an enlarged cross sectional view showing the front cover section 31 and the document discharge tray 24 in FIG. 3. FIG. 5 is a plan view showing the communication apparatus 20 seen from above in a state where the upper cover section 41 is open. In FIG. 3 and FIG. 4, a thickness is partially omitted. Moreover, in FIG. 3, the document supply tray 22 or the like is omitted so that the communication apparatus 20 is schematically shown. The base upper section 44 has the base engaging section 64 which is engaged with the cover engaging section 67 of the front cover section 31 as described above. The base engaging section 64 has, specifically a first protruding piece 65 and a second protruding piece 66. The first protruding piece 65 and the second protruding piece 66 are schematically vertical to the base upper section 44, and protrude downward from the base upper section 44. The first and second protruding pieces 65 and 66 are formed so as to have a platy shape, and thickness directions thereof are disposed so as to be schematically parallel. The first protruding piece 65 is disposed closer to the first main body side 30a compared to the second protruding piece 66. The second protruding piece 66 is disposed so as to be apart from the first protruding piece 65 and closer to the second main body side 30b.

The first protruding piece 65 and the second protruding piece 66 each have one surface which confronts each other formed so as to be a plane. A surface which is formed by the base upper section 44 and the first protruding-piece 65 and faces the first main body side 30a, that is one surface 64a which faces the first base side 40a of the base engaging section 64, is formed so as to be a plane. The one surface 64a of the base engaging section 64 is inclined downward to a direction close to the second main body side 40b. Thus, the base engaging section 64 is formed so as to have a concave shape by a part of the base upper section 44 and the first and second protruding pieces 65 and 66. With this base engaging section 64, engaged is the cover engaging section 67 of the front cover section 31 so as to be capable of releasing the engagement by a predetermined operation by the operator.

The second front cover side 31b of the front cover section 31 has the cover engaging section 67 with which the base engaging section 64 is engaged as described above. The cover engaging section 67 has a pawl section 68 which fits between the first protruding piece 65 and the second protruding piece 66 from a lower side. The pawl section 68 has a cross section which is vertical to the second horizontal direction formed so as to have an upwardly tapered shape in a state where the front cover section 31 closes the housing space 32. In a state where the cover engaging section 67 is engaged with the base engaging section 64, the first protruding piece 65 prevents the pawl section 68 from being displaced to a direction for opening the housing space 32.

In a state where the cover engaging section 67 is engaged with the base engaging section 64, the pawl section 68 has one surface 68a which faces the first protruding piece 65 thereof formed so as to be plane which is schematically parallel to the one surface of the first protruding piece 65. In a state where the cover engaging section 67 is engaged with the base engaging section 64, the one surface 68a of the pawl section 68 contacts with the one surface of the first protruding piece 68.

In a state where the cover engaging section 67 is engaged with the base engaging section 64, the pawl section 68 has other surface 68b which faces the second protruding piece 66 thereof formed so as to be a curved surface which has an adjacent region 73 and a remote region 74. In the adjacent region 73, the other surface 68b of the pawl section 68 is formed so as to have a curved surface which is close to the second protruding piece 66 toward a tip of the pawl section 68. In the remote region 74, the other surface 68b of the pawl section 68 is formed so as to be a curved surface which is apart from the second protruding piece 66 along a direction toward the tip of the pawl section 68. In a state where the cover engaging section 67 is engaged with the base engaging section 64, the other surface 68b of the pawl section 68 contacts with the second protruding piece 66 in the remote region 74.

In the embodiment, the front cover section 31 has a gravity point thereof included in one region which includes the front cover axial line L31 and is apart from the second main body side 30b compared to the other region, of two regions which are divided by a virtual plane perpendicular to the first horizontal direction. This enables that the front cover section 31 makes angular displacement to the first front cover angular displacement direction E1 by an own weight thereof when the engagement of the cover engaging section 67 and the base engaging section 64 is released.

The document discharge tray 24 is coupled so as to be capable of being angularly displaced about a document tray axial line L24 as a holding body angular displacement axial line relative to the front cover section 31. The document tray axial line L24 is an axial line in parallel with the front cover axial line L31. The document discharge tray 24 is coupled to the second front cover side 31b of the front cover section 31. The document discharge tray 24 can make angular displacement about the document tray axial line L24 between a document holding position 80 as a holding position and a document tray housing position 81 as a housing position in a state where the front cover section 31 is closed. The state where the front cover section 31 is closed is a state where the front cover section 31 closes the housing space 32.

At the document holding position 80, the document discharge tray 24 is disposed so as to extend in a direction of moving away from a side of the casing 21 in which a discharge port is formed, that is the first main body side 30a. The document discharge tray 24 receives, at the document receiving position 80, the document which is discharged from the document discharge port 35. At the document tray housing position 81, the document discharge tray 24 is disposed along the first main body side 30a so as to partially contact with the upper cover section 41. The document discharge tray 24 is, at the document holding position 80, held from a lower side by the second front cover section 31b, and hindered from making downward angular displacement.

The document discharge tray 24 has a first document tray section 70, a second document tray section 71, and a third document tray section 72. The first document tray section 70 is, at the document holding section 80, housed in the housing space 32. The first document tray section 70 has one end thereof, coupled to a vicinity of the cover engaging section 67 of the second front cover side 31b so as to be capable of making angular displacement about the document tray axial line L24. In addition, the first document tray section 70 has other end thereof, smoothly coupled to one end of the second document tray section 71. The first document tray section 70 is, at the document holding position 80, disposed so as to extend at downwardly slant along a direction close to the first main body side 30a in the first horizontal direction A. The first document tray section 70 is, at the document holding position 80, held by the second front cover side 31b from a lower side.

The second document tray section 71 has a convex section 24a. The convex section 24a protrudes upward at the document holding position 80. The convex section 24a is disposed in a vicinity of one end of the second document tray section 71. The convex section 24a contacts with the first upper cover section 41 at the document tray housing position 81. The second document tray section 71 has, at the document holding position 80, a remaining part not including the convex section 24a disposed so as to extend in schematically parallel with the first horizontal direction A. The second document tray section 71 has one end thereof, smoothly coupled to the other end of the first document tray section 70. In addition, the second document tray section 71 has other end thereof, smoothly coupled to one end of the third document tray section 72.

The third document tray section 72 extends, at the document holding position 80, at an upward slant toward a direction of moving away from the first main body side 30a in the first horizontal direction A. The third document tray section 72 has, in detail, a first upper inclined section 72a and a second upper inclined section 72b which are different each other in inclined amounts. The first upper inclined section 72a and the second upper inclined section 27b are smoothly coupled to each other. The first upper inclined section 72a is disposed closer to the second document tray section 71 than the second upper inclined section 72b so as to be smoothly coupled to other end of the second document tray section 71. The first upper inclined section 72a is disposed, for instance, so as to have a larger region which is disposed in parallel to the first horizontal direction A compared to the second upper inclined section 72b. The first upper inclined section 72a is disposed, for instance, so as to have a smaller inclined amount compared to the second upper inclined section 72b.

When the document discharge tray 24 disposed at the document holding position 80 receives the document, the discharged document has a leading end thereof, contacts with a middle part between one end and other end of the second document tray section 71. After that, the document is further discharged by the document conveying section 48, and then the document is displaced toward the third document tray section 72 along the second document tray section 71 while enlarging a region in contact with the document discharge tray 24. When the document is not given by an external force from the documents conveying section 48, the document is displaced by an inertial force along the second and third document tray sections 71 and 72. At the time, the first and second guide sections 47a and 47b are inclined downward from the document supply port 37 to the document discharge port 35 and therefore, it is possible to prevent troubles such that a tail end of the document is not discharged from the document discharge port 35, and easily discharge the document.

Furthermore, the third document tray section 72 is inclined upward to a direction of moving away from the first main body side 30a and therefore, on the document, acts a component force of an own weight thereof inversely to a traveling direction of the document. Thereby, the document gradually has a smaller displacing amount, and is finally locked so that a leading end thereof does not go beyond the second upper inclined section 72b. Consequently, the document which is discharged from the document discharge port 35 is held on the second document tray section 71 and the first third document tray section 72a. By thus constituting the document discharge tray 24, it is possible to reliably hold the document so as not to drop down from the document discharge tray 24.

In addition, the second upper inclined section 72b is formed so as to have a smaller inclined amount thereof than the first upper inclined section 72a. This makes it possible to easily take the document out when the operator takes the document out along the document discharge tray 24 in the first horizontal direction A, compared to a case where the inclined amount is formed so as to be smaller than the first upper inclined section 72a.

The convex section 24a is, in detail, disposed inside a region which is sandwiched between the document being in contact and the second document tray section 71 in a state where the document being discharged contacts with the middle part of the second document tray section 71. This makes it possible to prevent the convex section 24a from causing troubles on a discharging operation of the document, for instance, by touching the leading end of the document which is discharged. Furthermore, even when the document which is received by the document discharge tray 24 is displaced to a direction close to the first main body side 30a by the third document cover section 72, the tail end of the document is locked by the convex section 24a. This makes it possible to reliably receive the document at a predetermined position.

In the communication apparatus 20 which is constituted as described above, when the housing space 32 is opened by the front cover section 31, the operator operates the second front cover side 31b of the front cover section 31, for instance, by inserting a hand into the operation space 69 between the second front cover side 31b and the lower guide section 47b. On the second front cover side 31b is provided a press section 75 for opening the housing space 32. The press section 75 is disposed on a schematical center of the front cover side 31b and closer to the cover engaging section 67. The press section 75 confronts the lower guide section 47b in a state where the housing space 32 is closed. The operator presses this press section 75 and thereby, the engagement of the base engaging section 64 and the cover engaging section 67 is released, and the front cover section 31 is made to make angular displacement to the first front cover angular displacement direction E1.

The engagement of the base engaging section 64 and the cover engaging section 67 is released when an external force over a predetermined setting force is given to the press section 75 in a direction for opening the housing space 32. The direction for opening the housing space 32 means a direction which combines a direction in which the press section 75 is schematically vertical to the second front cover side 31b and which heads for the base side, and a direction which heads for the operator's side. The external force over the predetermined setting force means an external force which is necessary to release the engagement of the base engaging section 64 and the cover engaging section 67, for instance an external force such that the press section 75 is displaced downward in the up-and-down direction C by approximately 1 mm. When the operator gives the press section 75 the external force over the setting force in the direction for opening the housing space 32, by the resiliency of the front cover section 31, the second front cover side 31b makes angular displacement relative to the first front cover side 31a about an axial line in parallel with the second horizontal direction A. Thereby, the pawl section 68 of the cover engaging section 67 is displaced downward so as to be apart from the base engaging section 64.

In other words, the pawl section 68 is displaced downward along the first protruding piece 65 so as to be apart from the base engaging section 64. Since the external force is also given to the front cover section 31 in a direction which heads for the operator's side, when the pawl section 68 is disposed on a lower side than a lower side end of the first protruding piece 65 after that, the pawl section 68 slides toward the first base side 40a in a state of contacting with the tip of the first protruding piece 65 on the one surface 68a. Thereby, the cover engaging section 67 is apart from the base engaging section 64, and the engagement of the base engaging section 64 and the cover engaging section 67 is released. When the engagement is released, the front cover section 31 makes angular displacement to the first front cover angular displacement direction E1 by an own weight thereof even if the operator does not give the external force. Thus the operator operates the front cover section 31 and releases the housing space 32 as shown by an arrow F in FIG. 3 and FIG. 4. After that, the operator does works such as replacement of the ink cartridge 53 which is disposed closer to the operator as shown in FIG. 5.

Since the document discharge tray 24 is coupled to the front cover section 31, as shown by an arrow G in FIG. 3, together with the angular displacement of the front cover section 31 to the first front cover angular displacement direction E1, the document discharge tray 24 also slides about the first front cover angular displacement direction E1. Since the document discharge tray 24 is thus not fixed to the casing main body 30, troubles such that the working space becomes smaller and a mounting position of the ink cartridge 53 is blocked by the document discharge tray 24 are prevented from being caused. This makes it possible to reliably secure a large working space and enhance the workability.

At the time, the image forming section 52 is disposed in a vicinity of the front cover section 31 and on a lower side of the base upper section 44 and therefore, the operator can do the replacement work of the ink cartridge 53 close to oneself without inserting a hand deeply in the housing space 32 when the housing space 32 is opened by the front cover section 31. This allows the operator to do works easily and reliably when the housing space 32 is opened by the front cover section 31 and does works such as maintenance in the housing space 32. Consequently, it is possible to further enhance the workability in doing maintenance.

Furthermore, the document discharge tray 24 is coupled to the front cover section 31 so as to be capable of being angularly displaced about the document tray axial line L24 and therefore, the document discharge tray 24 can make angular displacement relative to the front cover section 31 and disposed along the placement board 27. This makes it possible to secure the working space large enough. In addition, the one surface 68a of the pawl section 68 is formed so as to be a curved surface which is closer to the other surface of the pawl section 68 along a direction of the tip and thereby, the engagement of the base engaging section 64 and the cover engaging section 67 can be easily released compared to a case where the pawl section 68 is formed so as to have a mere platy shape in a cuboid form.

The press section 75 is provided with a plurality of band sections 75a. Each band section 75a is formed so as to extend schematically in parallel with the second horizontal direction B and be apart from each other. The band section 75a has a cross section which is vertical to the second horizontal direction B so as to have a convex shape. By thus forming the band section 75a on the press section 75, the operator's finger is locked on the band section 75a when the operator presses the press section 75. This allows the operator to easily and reliably operate the front cover section 31 compared to a case where the press section 75 does not have protrusions such as the band section 75a, but a plane.

Since the document discharge tray 24 is provided on the front cover section 31, the document discharge tray 24 slides on the casing main body 30 about the front cover axial line L31 together with the angular displacement of the front cover section 31. Since the document discharge tray 24 is thus disposed at a position which is apart from the casing main body 30 in a state where the housing space 32 is open, the housing space 32 is not blocked by the document discharge tray 24 when the operator do works so that it is possible to reliably secure a large working space and enhance the workability. Furthermore, the document discharge tray 24 is, relative to the front cover section 31, coupled about the document tray axial line L24 so as to be capable of being angularly displaced and therefore, the document discharge tray 24 can be disposed along the placement board 27. This makes it possible to secure the working space large enough.

In addition, as shown in FIG. 5, the document discharge tray 24 is formed by bending a bar-shaped member which has a circular cross section so as to have a general U shape. The document discharge tray 24 is formed of a material which has resiliency. In the embodiment, the document discharge tray 24 has two first document tray sections 70, two second document tray sections 71, and one third document tray section 72. The document discharge tray 24 is formed so as to be expansively open along a direction of the first document tray section 70 in a natural state of not being coupled to the front cover section 31. The first document tray section 70 of the document discharge tray 24 has one end which is coupled to the second front cover side 31b formed so as to be curved in an L shape toward the second horizontal direction B. The one end of the first document tray section 70 is coupled to the front cover section 31 on two insertion sections 82a and 82b of the curved section in the L shape, which are parallel to the horizontal direction B.

On the front cover section 31, as shown in FIG. 5, two pawl sections 68 are disposed so as to be apart from each other. The second front cover side 31b has two sides 84a and 84b which confront each other and are schematically vertical to the second horizontal direction B. The two sides 84a and 84b of the second front cover side 31b are disposed so as to have a larger distance therebetween than a distance of the two pawl sections 68. On these two sides 84a and 84b are formed through holes 83a and 83b which penetrate in the second horizontal direction B. The through holes 83a and 83b of the second front cover section 31b are formed so as to be slightly larger compared to sizes of the insertion sections 82a and 82b of the first document tray section 70. Into the through holes 83a and 83b of the second front cover section 31b, the insertion sections 82a and 82b of the first document tray section 70 are inserted.

The insertion sections 82a and 82b contact with the second front cover side 31b from a lower side in a state of being inserted into the through holes 83a and 83b. In addition, the document discharge tray 24 is formed so as to be expansively open toward the first document tray section 70 and therefore, the document discharge tray 24 is reliably coupled to the first document tray section 70 in a state where the first document tray section 70 gives a certain press force to the sides 84a and 84b of the second front cover section 31b. In addition, the insertion sections 82a and 82b contact with the second front cover side 31b from a lower side and therefore, it is possible to hinder downward angular displacement of the first document tray section 70. The document discharge tray 24 is thus coupled to the front cover section 31 so as to be capable of being angularly displaced about the document tray axial line L24 and be detachable.

When the works such as replacement of the ink cartridge 53 ends and the housing space 32 is closed by the front cover section 31, the operator angularly displaces the front cover section 31 toward the second front cover angular displacement direction E2. At the time, the cover engaging section 67 and the base engaging section 64 are engaged with each other so that the front cover section 31 and the base upper section 44 are coupled to each other. Specifically, when the front cover section 31 makes angular displacement to the second front cover angular displacement direction E2, the pawl section 68 contacts with the one surface 64a of the base engaging section 64 in the adjacent region 73. Furthermore, the front cover section 31 makes angular displacement to the second front cover angular displacement direction E2 and then, the pawl section 68 slides toward the tip of the first protruding piece 65 of the base engaging section 64 while being displaced toward the first base side 40a in a state of contacting with the one surface 64a of the base engaging section 64 in the adjacent region 73.

When the front cover section 31 makes further angular displacement to the second front cover angle displacement direction E2, the pawl section 68 slides the tip of the first protruding piece 65 toward the second base side 40b while changing a region which contacts with the one surface 64a of the base engaging section 64 from the adjacent region 73 to the remote region 74 in addition to a downward displacement on the tip of the first protruding piece 65. The tip of the pawl section 68 slides the tip of the first protruding piece 65 toward the second base side 40b, and is apart from the tip. In addition, the pawl section 68 slides the base engaging section 64 in a state of being in line contact with the one surface 64a of the base engaging section 64. After that, the pawl section 68 is fitted between the first protruding piece 65 and the second protruding piece 66 from a lower side so that the base engaging section 64 and the cover engaging section 67 are engaged with each other. Thereby, the base upper section 44 and the front cover section 31 are coupled to each other, and the housing space 32 is closed by the front cover section 31.

The pawl section 68 has one surface 68a thereof, formed so as to be a curved surface, and is in line contact when sliding the base engaging section 64 and therefore, it is possible to make a frictional force which is received from the one surface of the base engaging section 64 so as to be as small as possible compared to a case of being formed so as to be a plane. This may make it possible to facilitate the base engaging section 64 and the cover engaging section 67 to be easily engaged with each other. By thus constituting the front cover section 31, the operator can easily open and close the housing space 32 by operating the front cover section 31.

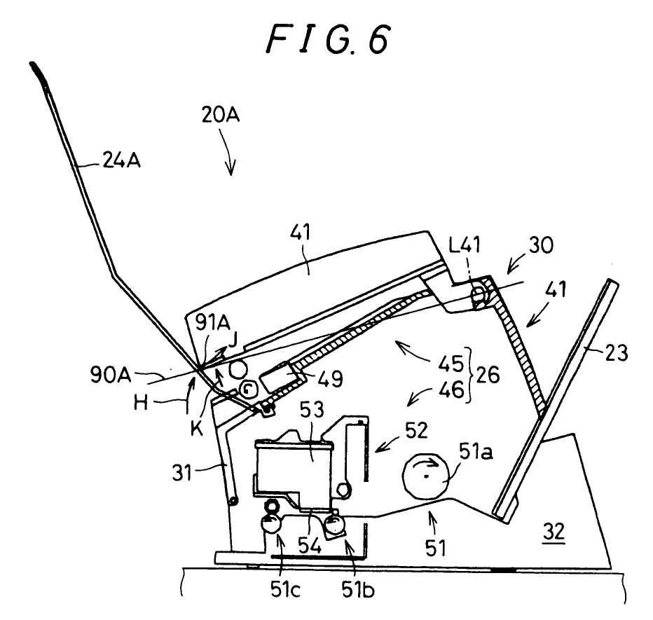

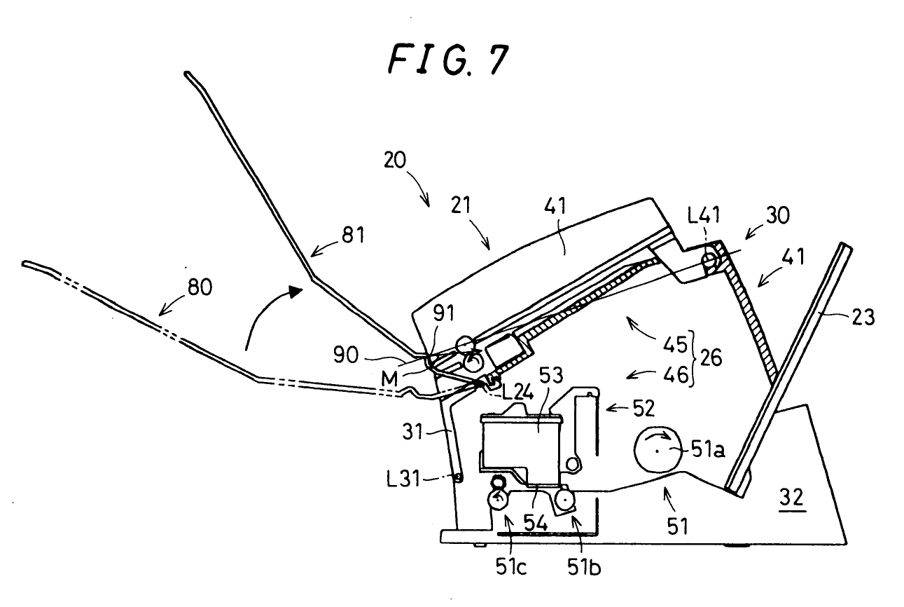

FIG. 6 is a view for explaining an operation of the upper cover section 41 when the document discharge tray 24 having no convex section 24a is displaced toward a housing position of a document tray. FIG. 7 is a view for explaining an operation of the upper cover section 41 when the document discharge tray 24 having the convex section 24a is displaced toward the housing position of the document tray. In FIG. 6 and FIG. 7, a thickness is partially omitted. Moreover, in FIG. 6, since only a constitution of the document discharge tray 24 is different, the same reference numeral is given to the same constitution and a description will be omitted. In the communication apparatus 20A in FIG. 6, the document discharge tray 24 has no convex section 24a, but is coupled to the front cover section 31 and therefore, it is possible to secure a large working space and enhance the workability.

In a state where the communication apparatus 20A is used, the document discharge tray 24A contacts with and presses on the lower guide section 47b from a lower side when, for instance, the operator touches the document discharge tray 24A so that an external force which makes angular displacement toward the document tray housing position is given by mistake as shown by an arrow H in FIG. 6. A pressing direction in which the document discharge tray 24 presses the lower guide section 47b becomes a direction which heads for the upper cover section 41 rather than a first virtual plane 90A as shown by an arrow J in FIG. 6. The first virtual plane 90A is a virtual plane including a contact position 91A of the document discharge tray 24 in the upper cover section 41, and the upper cover axial line L41 of the upper cover section 41. The contact position 91A moves upward according to a magnitude of a rotational moment based on the external force which is given to the document discharge tray 24. According to this magnitude of the rotational moment, the lock mechanism is released, and the upper cover section 41 makes angular displacement, as shown by an arrow K in FIG. 6, to the first upper cover angular displacement direction D1 by the document discharge tray 24A.

Even if the upper cover section 41 makes angular displacement to the first displacement direction D1 and thereafter, the external force given to the document discharge tray 24 is lost and the upper cover section 41 is back in a vicinity of a position in a state where the communication apparatus 20 is used, the document cannot be accurately conveyed when there is a slight gap between the document reading section 49 and the document feeding roller 48b. In this case, the troubles cannot be resolved unless the operator intentionally gives the external force to the upper cover section 41 so as to head for the second upper cover angular displacement direction D2.

The above-mentioned troubles can be resolved by providing the convex section 24a on the document discharge tray 24. When the external force which makes angular displacement toward the document tray housing position 81 is given to the document discharge tray 24a, the document discharge tray 24a contacts with the first upper cover side 41a on the convex section 24a. The pressing direction of the press force which the convex section 24a gives to the first upper cover side 41a becomes, as shown by an arrow M in FIG. 7, a direction which heads closer for the base 40 than a second virtual plane 90. The second virtual plane 90 is a virtual plane including a contact position 91 of the document discharge tray 24a in the upper cover section 41, and the upper cover axial line L41.

The convex section 24a curves in a ridge form which protrudes generally upward as seen from a side in the second horizontal direction B. The convex section 24a is formed so as to contact with the first upper cover section 41 on a slope part of a several millimeters, which is closer to the first base side 41a, of the curved part. This causes either that the rotational moment which is given to the upper cover section 41 on the contact section 91 is extremely small or that the external force which makes angular displacement to the second upper cover angular displacement direction D2 is given to the upper cover section 41. This makes it possible to prevent angular displacement of the upper cover section 41 to the first upper cover angular displacement direction D1 and to prevent the lock mechanism from being released. Consequently, a process by the document processing means 45 can be reliably performed.

A disposing position and shape of the convex section 24a in the document discharge tray 24 are determined in view of, for instance, a position of the upper cover axial line. L41 and an inclined angle of the first upper cover side 41a against the placement board 27a. In addition, an inclined angle of the first document tray section 70 or the like is also determined according to a disposing state of the front cover section 31, the upper cover section 41 and the like. Moreover, even when an undesired external force is given to the document discharge tray 24, the document discharge tray 24 has resiliency and therefore is back in an original state when the external force is lost. It is possible to prevent a failure of reading the image on the document, which is attributed to the undesired external force given to the document discharge tray 24, for instance, by being touched, and an occurrence of uneven feeding when the document is conveyed.

The operator can open the housing space 32 by giving the external force over the setting force in a direction for opening the front cover section 31 by use of the document discharge tray 24 instead of pressing the press section 75 by one's own finger. Specifically, the operator disposes the document discharge tray 24 at the document tray housing position, and in a U state, gives the external force which heads for the second front cover side 31b to the document discharge tray 24. Thereby, similarly to the case where the operator operates the press section 75 so as to open the housing space 32, the engagement of the base engaging section 64 and the cover engaging section 67 is released so that the housing space 32 is open.

The document discharge tray 24 can be thus used not only as means for holding the document from the document discharge port 35, but also as means for operating the front cover section 31 in order to open the housing space 32. Furthermore, the document discharge tray 24 is disposed on the second front cover side 31b and therefore, it is possible to efficiently give the external force over the setting force to the second front cover side 31b through the document discharge tray 24. This makes it possible to easily release the engagement of the base engaging section 64 and the cover engaging section 67, and prevent a deformation and a breakage of the front cover section 31 and the document discharge tray 24.

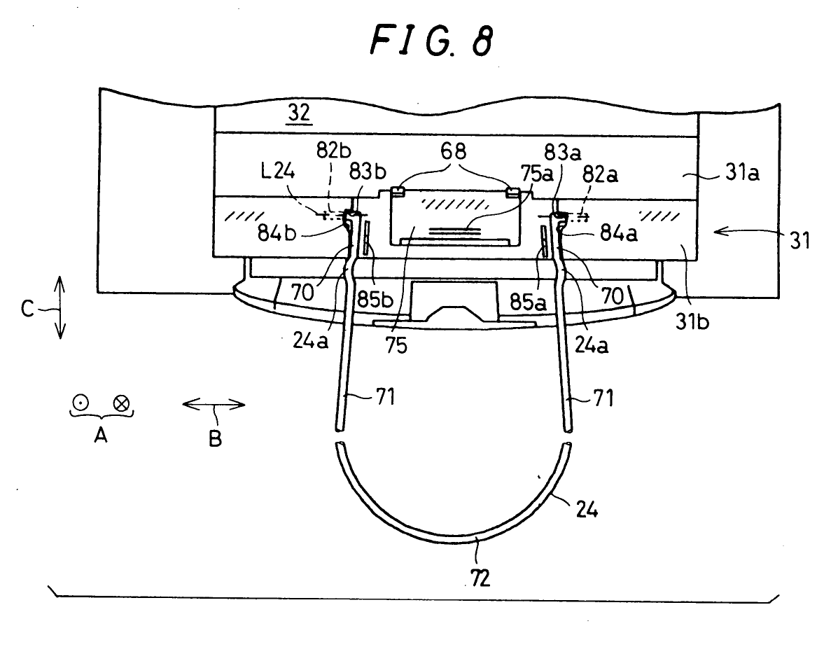

FIG. 8 is a view for explaining a relation of the document discharge tray 24 and the front cover section 31. The two sides 84a and 84b of the second front cover side 31b are disposed so as to extend between the one end and other end of the second front cover side 31b. The two sides 84a have, regions which extend in parallel with each other from one end to the other end of the second front cover side 31b, a region in which a through hole is formed, regions which are curved so as to be close each other toward the other end of the second front cover side 31b, and regions which extends in parallel with each other. When the document discharge tray 24 is coupled to the front cover section 31, the insertion section 82a on one side of the first document tray section 70 is guided along the side 84a on one side of the second front cover side 31b. At the time, the insertion section 82b on the other side of the first document tray section 70 is guided along the side 84b on the other side of the second front cover side 31b.

In addition, the two first document tray sections 70 are displaced so as to be apart from each other in order to be back in a natural state from a state of being close each other compared to the natural state. After that, the insertion section 82a on the one side is inserted into the through hole 83a on the one side while the insertion section 82b on the other side is inserted into the through hole 83b on the other side. By thus constituting the two sides 84a and 84b of the second front cover side 31b, it is possible to easily couple the document discharge tray 24 to the front cover section 31.

Furthermore, on the second front cover side 31b, two ribs 85a and 85b are provided between the side 84a on the one side and the side 84b on the other side in the second direction B. The two ribs 85a and 85b are provided so as to protrude from the second front cover side 31b toward a side on which the second front cover side 31b is confronted by the lower guide section 47b. The rib 85a on the one side is disposed so as to be apart from the side 84a on the one side in the second horizontal direction B. The rib 85a on the one side extends between a region in which the through hole 83a on the one side is formed on the side 64a on the one side, and a region which extends in parallel with each other, along a direction from the one end to the other end of the second front cover side 31b.

The rib 85b on the other side is disposed so as to be apart from the side 84b on the other side in the second horizontal direction B. The rib 85b on the other side extends between a region in which the through hole 83b on the other side is formed on the side 64b on the other side, and a region which extends in parallel with each other, along a direction from the one end to the other end of the second front cover side 31b. The protruding amount of the two ribs 85a and 85b are formed so as to be, for instance, approximately a half of an outside diameter dimension of the document discharge tray 24 or less. In the embodiment, the two ribs 85a and 85b are made to have a part in a vicinity of the through holes 83a and 83b having the larger protruding amounts compared to a part in a vicinity of the other end of the second front cover side 31b. This allows, for instance, the operator to touch the document discharge tray 24 so as to lock the first document tray section 70 by the two ribs 85a and 85b when the external force to the document discharge tray 24 is extremely small.

Moreover, when the large external force is given along the axial line of the insertion section 82a and 82b, that is the document tray axial line L24 by contact or the like in a state where the document discharge tray 24 is coupled to the front cover section 31, the document discharge tray 24 has resiliency and therefore is deformed and detached from the front cover section 31. This makes it possible to prevent the document discharge tray 24 from being undesirably deformed and the sides 84a and 84b of the second front cover side 31b from being broken. In addition, the document discharge tray 24 is coupled in a vicinity of the cover engaging section 67 of the second front cover side 31b and therefore, an appearance of the communication apparatus 20 is not damaged so that a design characteristic can be enhanced.

According to the embodiment, the document discharge tray 24 is provided on the front cover section 31. This makes is possible to dispose the document discharge tray 24 apart from the casing main body 30 as well as the front cover section 31 so as not to be an impediment when the front cover section 31 is made to be displaced relative to the casing main body 30 so as to open the housing space 32. Consequently, it is possible to prevent the document discharge tray 24 from narrowing the working space and the large working space can be secured when the operator is doing maintenances, for instance, a work operation for replacing consumable articles such as the ink cartridge 53, and a work operation for removing dust attached to a roller for conveying the sheet member. Furthermore, there is no document discharge tray 24 before the operator's eyes and therefore, the housing space 32 is prevented from being blocked so that the operator can visually look at the housing space 32 reliably. This makes it possible to enhance the workability.

In addition, according the invention, the front cover section 31 is coupled about the predetermined front cover axial line L31 so as to be capable of angular displacement relative to the casing main body 30. The document discharge tray 24 coupled so as to be capable of being angularly displaced about the document tray axial line L24 in parallel with the front cover axial line L31 relative to the front cover section 31. This makes it possible to angularly displace the document discharge tray 24 on the front cover section 31 and further expand the working space when the front cover section 31 is made to make angular displacement so as to open the housing space 32. In addition, the workability can be enhanced.

Further, according to the embodiment, even if the operator touches the document discharge tray 24 by mistake and the document discharge tray 24 makes angular displacement so as to contact with the upper cover section 41, the press force due to the document discharge tray 24 is given in a direction for closing the upper cover section 41. This makes it possible to prevent the upper cover section 41 from making angular displacement by mistake in a direction for opening the housing space 32. Consequently, by opening the housing space 32, it is possible to prevent the troubles such that the process on the sheet member is not performed so that the process on the sheet member can be reliably performed.

Further, according to the embodiment, it is possible to reliably give the press force due to contact of the convex section 24a on the upper cover section 41, to a direction for closing the upper cover section 41, when the convex section 24a contacts with the upper cover section 41. This makes it possible to reliably prevent the upper cover section 41 from making angular displacement so that the housing space 32 is opened even if the operator touches the document discharge tray 24 by mistake so that the document discharge tray 24 and the upper cover section 41 come in contact.

Further, according to the embodiment, in a state where the front cover section 31 is engaged with the casing main body 30, by use of the document discharge tray 24a which is coupled to the second front cover side 31b of the front cover section 31, the external force over the setting force is given and thereby, the engagement of the front cover section 31 and the casing main body 30 can be released. This makes it possible to use the document discharge tray 24 not only as means for holding the document from the document discharge port 35, but also as means for operating the front cover section 31 in order to open the housing space 32. By further use of the document discharge tray 24, the external force over the setting force is efficiently given to the second front cover side 31b of the front cover section 31 so that the engagement of the front cover section 31 and the casing main body 30 can be easily released, and the deformation and the breakage of the front cover section 31 and the document discharge tray 24 can be prevented.

Further, according to the embodiment, the document discharge tray 24 is provided so as to be detachable from the front cover section 31 when the external force in a direction along the document tray axial line L24 is given. Thereby, the document discharge tray 24 is detached from the front cover section 31 if the external force which is given to the document discharge tray 24 is in a direction along the document tray axial line L24 when the operator touches the document discharge tray 24 by mistake. Consequently, it is possible to prevent the front cover section 31 and the document discharge tray 24 from undesirably being deformed and broken by the external force.

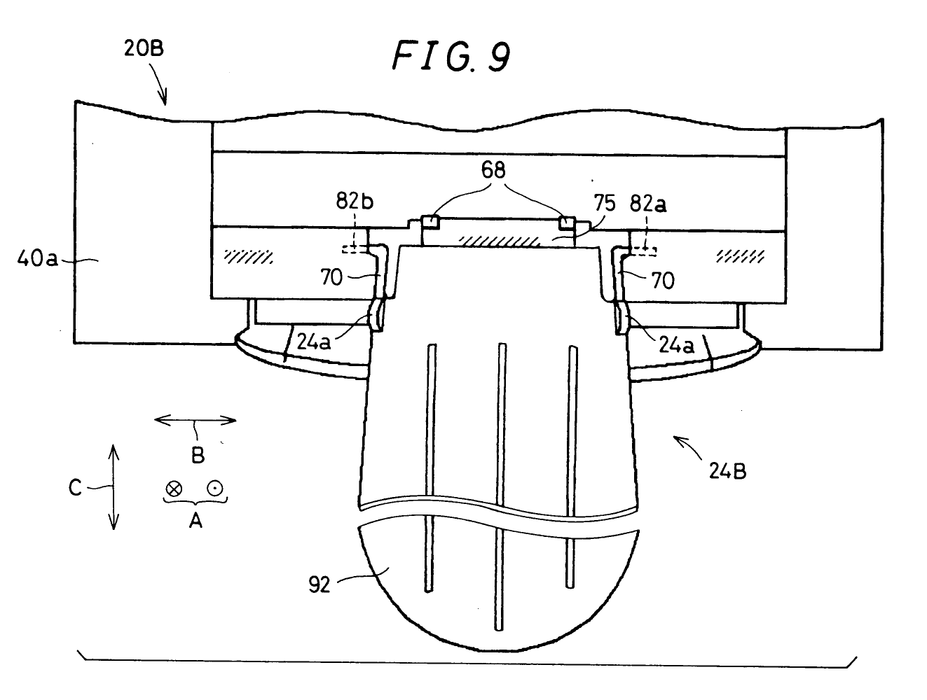

FIG. 9 is a view for explaining a document discharge tray 24B equipped with a communication apparatus 20B according to another embodiment of the invention. In the communication apparatus 20B in the embodiment, the other constitution except the document discharge tray 24B is the same as the communication apparatus 20 according to the above-described one embodiment. The same reference numeral is given to the same constitution and the same description will be omitted. On the document discharge tray 24B except a part between the convex section 24a and the insertion sections 82a and 82b, a platy holding member 91 is provided in the first horizontal direction A. The same effect as the communication apparatus 20 according to the above-described one embodiment can be obtained, and for instance, the document is prevented from dropping from an opening port which is formed by the above-described document discharge tray 24 so that it is possible to deal with documents of various sizes.

The above-described embodiment is merely an illustration of the invention, and the constitution may be changed within the invention. For instance, the sheet member processing apparatus may be image forming apparatuses such as a compact copying machine and a scanning printer, and a multifunctional apparatus equipped with a document reading function and a printing recording function. In addition, if the constitution is such that the upper cover section 31 cannot open the housing space 32, even the above-described communication apparatus 20A which is shown in FIG. 6 can sufficiently achieve the object of the invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

According to the invention, the sheet member holding body is provided on the lid body and therefore, the sheet member holding body can be made to be displaced together with the lid body so that the sheet member holding body can be disposed so as not to be an impediment when the lid body is made to be displaced relative to the casing main body so as to open the housing space. This makes it possible to prevent the sheet member holding body from narrowing the working space and secure the large working space when an operator is doing maintenances, for instance, a work operation for replacing consumable articles such as an ink cartridge, and a work operation for removing dust attached to a roller for conveying the sheet member. Furthermore, there is no sheet member holding body before the operator's eyes and therefore, the housing space is prevented from being blocked by the sheet member holding body so that the operator can visually look at the housing space reliably. This makes it possible to enhance the workability.

Further, according to the embodiment, the lid body is coupled so as to be capable of being angularly displaced about the predetermined lid body angular displacement axial line relative to the casing main body. The sheet member holding body is coupled so as to be capable of being angularly displaced about the holding body angular displacement axial line in parallel with the lid body angular displacement axial line relative to the lid body. This makes it possible to angularly displace the sheet member holding body relative to the lid body so as to have a working space wide enough when the lid body is made to make angular displacement so as to open the housing space. In addition, the workability can be enhanced.

Further, according to the embodiment, even when the operator touches the sheet member holding body, and the sheet member holding body makes angular displacement and contacts with the cover section, the press force due to the sheet member holding body is given to the direction for closing the cover section. This prevents the cover section from making angular displacement in an opening direction by mistake. Consequently, by having the housing space being open, troubles such that a process on the sheet member is not performed can be prevented from occurring so that the process can be reliably performed on the sheet member.

Further, according to the embodiment, the press force due to the contact of the convex section on the cover section can be made to be reliably given to the direction for closing the cover section when the convex section contacts with the cover section. This makes it possible to reliably prevent the cover section from making angular displacement so that the housing space is opened even if the operator touches the sheet member holding body by mistake so that the sheet member holding body and the cover section come in contact.

Further, according to the embodiment, in a state where the lid body is engaged with the casing main body, by use of the sheet member holding body which is coupled to the other side of the lid body, the external force over the setting force is given and thereby, the engagement of the lid body and the casing main body can be released. This makes it possible to use the sheet member holding body not only as means for holding the sheet member from the discharge port, but also as means for operating the lid body in order to open the housing space. By further use of the sheet member holding body, the external force over the setting force is efficiently given to the other side of the lid body and thereby, the engagement of the lid body and the casing main body can be easily released, and the deformation and the breakage of the lid body and the sheet member holding body can be prevented.

Further, according to the embodiment, the sheet member holding body is provided so as to be detachable from the lid body when the external force in a direction along the holding body angular displacement axial line is given. Thereby, the sheet member holding body is detached from the lid body if the external force which is given to the sheet member holding body in a direction along the holding angular displacement axial line when the operator touches the sheet member holding body by mistake. Consequently, it is possible to prevent the lid body and the sheet member holding body from being broken by the external force.

1. A sheet member processing apparatus comprising:
processing means for performing a predetermined process on a sheet member;
a casing having a casing main body and a lid body, in which a housing space capable of being opened and closed by displacing the lid body relative to the casing main body, for housing the processing means is formed, and in an upper side than the lid body is formed a discharge port for discharging a sheet member processed by the processing means; and
a sheet member holding body for holding a sheet member discharged from the discharge port.

2. The sheet member processing apparatus of claim 1, wherein:
the lid body is coupled so as to be capable of being angularly displaced about a predetermined lid body angular displacement axial line relative to the casing main body; and
the sheet member holding body is coupled so as to be capable of being angularly displaced about a holding body angular displacement axial line in parallel with the lid body angular displacement axial line relative to the lid body.

3. The sheet member processing apparatus of claim 1, wherein:
the casing main body has a base to which the lid body is coupled, and a cover section, and the casing main body is constituted to be capable of opening and closing the housing space by displacing the cover section relative to the base; and
in a state where a lid body is closed, the sheet member holding body is capable of being angularly displaced about a predetermined angular displacement axial line of the sheet member holding body between a holding position where the sheet member holding body is disposed so as to extend in a direction of moving away from a side of the casing in which a discharge port is formed and on which holding position the sheet member discharged from the discharge port is received, and a housing position which is positioned along the side of the casing in which the discharge port is formed so that the sheet member holding body partially contacts with the cover section, and in a state of being in the housing position a press force due to contact of the sheet member holding body with the cover is given to a direction for closing the cover section.

4. The sheet member processing apparatus of claim 3, wherein:
the cover section is coupled to the base so as to be capable of being angularly displaced about a cover angular displacement axial line in parallel with the holding angular displacement axial line; and
the sheet member holding body has a convex section which contacts with the cover section in a state of being disposed at the housing position, and the convex section is formed so that in a state of contacting with the cover section, a pressing direction for pressing the cover section is a direction which is directed closer to the base than a virtual plane including a contact position of the convex section in the cover section and the cover angular displacement axial line.

5. The sheet member processing apparatus of claim 1, wherein:
the lid body is coupled in one side thereof to the casing main body so as to be capable of being angularly displaced about the predetermined lid body angular displacement axial line, and engaged in the other side thereof with the casing main body so as to be capable of releasing the engagement when an external force over a predetermined setting force is given to a direction for opening the housing space; and
the sheet member holding body is coupled to the other side of the lid body.

6. The sheet member processing apparatus of claim 1, wherein the sheet member holding body is disposed so as to be detachable from the lid body when an external force in a direction along the holding body angular displacement axial line is given.

7. The sheet member processing apparatus of claim 2, wherein:
the casing main body has a base to which the lid body is coupled, and a cover section, and the casing main body is constituted to be capable of opening and closing the housing space by displacing the cover section relative to the base; and
in a state where a lid body is closed, the sheet member holding body is capable of being angularly displaced about a predetermined angular displacement axial line of the sheet member holding body between a holding position where the sheet member holding body is disposed so as to extend in a direction of moving away from a side of the casing in which a discharge port is formed and on which holding position the sheet member discharged from the discharge port is received, and a housing position which is positioned along the side of the casing in which the discharge port is formed so that the sheet member holding body partially contacts with the cover section, and in a state of being in the housing position a press force due to contact of the sheet member holding body with the cover is given to a direction for closing the cover section.

8. The sheet member processing apparatus of claim 2, wherein:
the lid body is coupled in one side thereof to the casing main body so as to be capable of being angularly displaced about the predetermined lid body angular displacement axial line, and engaged in the other side thereof with the casing main body so as to be capable of releasing the engagement when an external force over a predetermined setting force is given to a direction for opening the housing space; and
the sheet member holding body is coupled to the other side of the lid body.

9. The sheet member processing apparatus of claims 3, wherein:
the lid body is coupled in one side thereof to the casing main body so as to be capable of being angularly displaced about the predetermined lid body angular displacement axial line, and engaged in the other side thereof with the casing main body so as to be capable of releasing the engagement when an external force over a predetermined setting force is given to a direction for opening the housing space; and
the sheet member holding body is coupled to the other side of the lid body.

10. The sheet member processing apparatus of claim 4, wherein:
the lid body is coupled in one side thereof to the casing main body so as to be capable of being angularly displaced about the predetermined lid body angular displacement axial line, and engaged in the other side thereof with the casing main body so as to be capable of releasing the engagement when an external force over a predetermined setting force is given to a direction for opening the housing space; and
the sheet member holding body is coupled to the other side of the lid body.

11. The sheet member processing apparatus of claim 2, wherein the sheet member holding body is disposed so as to be detachable from the lid body when an external force in a direction along the holding body angular displacement axial line is given.

12. The sheet member processing apparatus of claim 3, wherein the sheet member holding body is disposed so as to be detachable from the lid body when an external force in a direction along the holding body angular displacement axial line is given.

13. The sheet member processing apparatus of claim 4, wherein the sheet member holding body is disposed so as to be detachable from the lid body when an external force in a direction along the holding body angular displacement axial line is given.

14. The sheet member processing apparatus of claim 5, wherein the sheet member holding body is disposed so as to be detachable from the lid body when an external force in a direction along the holding body angular displacement axial line is given.
